(19) United States
(12) Patent Application Publication
(10) Pub. No.: US 2016/0080572 A1
(43) Pub. Date: Mar. 17, 2016

(54) CALL DROP INTELLIGENT ENGINE

(71) Applicant: Verizon Patent and Licensing Inc.

(72) Inventors: Lingeswaran MURUGASEN, Chennai (IN); Vijayanand Chidambaram, Chennai (IN)

(73) Assignee: VERIZON PATENT AND LICENSING, INC., Basking Ridge, NJ (US)

(21) Appl. No.: 14/486,088

(22) Filed: Sep. 15, 2014

(51) Int. Cl. H04M 3/523; H04M 3/42

(52) U.S. Cl. CPC H04M 3/5231; H04M 3/42195

(57) ABSTRACT

The disclosed embodiments provide systems and methods for managing calls received by a call center. In one embodiment, a method is disclosed that may include receiving and routing a first call to a first agent. The method may also include determining completed steps of a troubleshooting process and storing session information comprising a list of the completed steps of the troubleshooting process. The method may further include creating a call drop ticket associated with the session information if the first call is disconnected before the troubleshooting process is completed. In one aspect, the method may include receiving a second call, and, if the second call is associated with the call drop ticket, bypass running of a call routing script; routing the second call to a second agent; and displaying, to the second agent, the completed steps stored in the session information.

### TECHNICAL FIELD

The present invention generally relates to systems and methods for managing call management functions in a call center, such as call setup, call routing/re-routing and call reconnections. More particularly, the present invention relates to systems and methods for intelligently reconnecting a customer to an agent and restoring a troubleshooting session after a dropped call.

### BACKGROUND

Many organizations, including business entities and telecommunication providers, use call centers to manage calls received from customers regarding inquiries on various subjects such as billing, repair, order status, and others.

When a customer dials into a call center via a device such as a telephone, a call center may use voice prompts or call routing scripts to route the customer to an appropriate customer service agent. Such prompts may require a customer to enter various information including, for instance, the customer's identity, or the reason for the call. The customer may also be placed in a queue to await the next available agent.

Once the customer gets connected to an agent, the customer and the agent may interact during the call. The customer may explain the details of the problem or issue that requires resolution. The agent may interact with a call center system to determine the steps required to resolve the problem.

When a resolution is reached between the customer and the agent, the agent may create a “ticket” associated with the resolution and the call may be ended.

However, in certain situations, the customer may be disconnected prematurely for a variety of reasons including network failures, telephone failures, or general system failures. In such cases, the customer may be required to place a second call and go through the same series of steps before finally reaching an agent. The delays resulting from restarting the call process in order to reach an agent may be time consuming and frustrating to the customer.

In addition, the customer may reach an agent different than the first, and the customer is then forced to again describe the issue to the second agent, even though he or she has previously described the issue to the first agent. Also, the troubleshooting steps carried out by the agent prior to the dropped call may not be saved. Even where a call drop ticket is created, the second agent may only be able to view the reason for the dropped call and not view any steps previously taken to resolve the issue before the first call was dropped. This may result in further delays as the customer waits for the agent to restart the troubleshooting process.

Further, the average handling time (AHT) of each call may increase as the agents restart the troubleshooting process from scratch after each dropped call. This may result in reduced call handling efficiency.

The problems resulting from dropped calls result in an inefficient and time-consuming process for both customers and agents. The business organization may also risk losing customers who become frustrated by the overall delays in getting service after dropped calls.

Therefore, there is a need for improved systems and methods for intelligently managing dropped calls and allowing a caller to access an agent to resume the troubleshooting process after a dropped call.

### SUMMARY

Consistent with embodiments of the present invention, systems and methods are disclosed for intelligently handling call management functions in a call center, such as call setup, call routing/re-routing, and call reconnections, including intelligently reconnecting a customer to an agent and restoring the troubleshooting session after a dropped call.

In one aspect, a system for managing calls received by a call center may comprise a call receiving unit configured to receive a first call from a customer and route the first call to a first agent. The system may further comprise a call processing unit configured to determine completed steps of a troubleshooting process. The system may also comprise a session storage unit configured to store session information, the session information comprising a list of the completed steps of the troubleshooting process. The call processing unit may be configured to create a call drop ticket associated with the session information if the first call is disconnected before the troubleshooting process is completed. The call receiving unit may be configured to receive a second call, determine whether the second call is associated with the call drop ticket, bypass run a call routing script if the second call is associated with the call drop ticket, and route the second call to a second agent if the second call is associated with the call drop ticket. The call processing unit may be configured to display to the second agent the completed steps stored in the session information if the second call is associated with the call drop ticket.

In another aspect, a method for managing calls received by a call center may comprise receiving, by a processor, a first call from a customer and routing, by the processor, the first call to a first agent. The method may also include determining, by the processor, completed steps of a troubleshooting process. In one aspect, the method may comprise storing, by the processor, session information, the session information comprising a list of the completed steps of the troubleshooting process. The process may further comprise creating, by the processor, a call drop ticket associated with the session information if the first call is disconnected before the troubleshooting process is completed. In another aspect, the method may include receiving, by the processor, a second call. The method may also include determining, by the processor, whether the second call is associated with the call drop ticket. In one embodiment, the method may comprise bypass running, by the processor, a call routing script if the second call is associated with the call drop ticket, and routing, by the processor, the second call to a second agent if the second call is associated with the call drop ticket. In another embodiment, the method may include displaying, by the processor to the second agent, the completed steps stored in the session information if the second call is associated with the call drop ticket.

In yet another aspect, a non-transitory computer-readable medium is disclosed, the medium storing instructions that, when executed by a processor, cause the processor to perform operations that may comprise receiving a first call from a customer and routing the first call to a first agent. The medium may store instructions that cause the processor to perform operations further comprising determining completed steps of a troubleshooting process, and storing session information, the session information comprising a list of the completed steps of the troubleshooting process. In another embodiment, the medium may store instructions that cause the processor to perform operations further including creating a call drop ticket associated with the session information if the first call is disconnected before the troubleshooting process is completed. The medium may also store instructions that cause the processor to perform operations further comprising receiving a second call, determining whether the second call is associated with the call drop ticket, bypass running a call routing script if the second call is associated with the call drop ticket, and routing the second call to a second agent if the second call is associated with the call drop ticket. In other aspects, the medium may store instructions that cause the processor to perform operations further comprising displaying to the second agent the completed steps stored in the session information if the second call is associated with the call drop ticket.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary system for managing calls received by a call center, consistent with an embodiment of the present invention;

FIG. 2 is a flow chart of an exemplary method for managing calls received by a call center, consistent with an embodiment of the present invention;

FIG. 3 is a flow chart of an exemplary method for managing call setup, call routing/re-routing and call reconnections in a call center, consistent with an embodiment of the present invention; and

FIG. 4 is a functional block diagram of an exemplary computer system consistent with an embodiment of the present invention.

### DETAILED DESCRIPTION

The following detailed description refers to the accompanying drawings. Wherever possible, the same reference numbers are used in the drawings and the following description to refer to the same or similar parts. While a presently preferred embodiment and features of the invention are described herein, modifications, adaptations and other implementations are possible, without departing from the spirit and scope of the invention. For example, substitutions, additions or modifications may be made to the components illustrated in the drawing, and the exemplary methods described herein may be modified by substituting, reordering, or adding steps to the disclosed methods. Accordingly, the following detailed description does not limit the invention. Instead, the proper scope of the invention is defined by the appended claims.

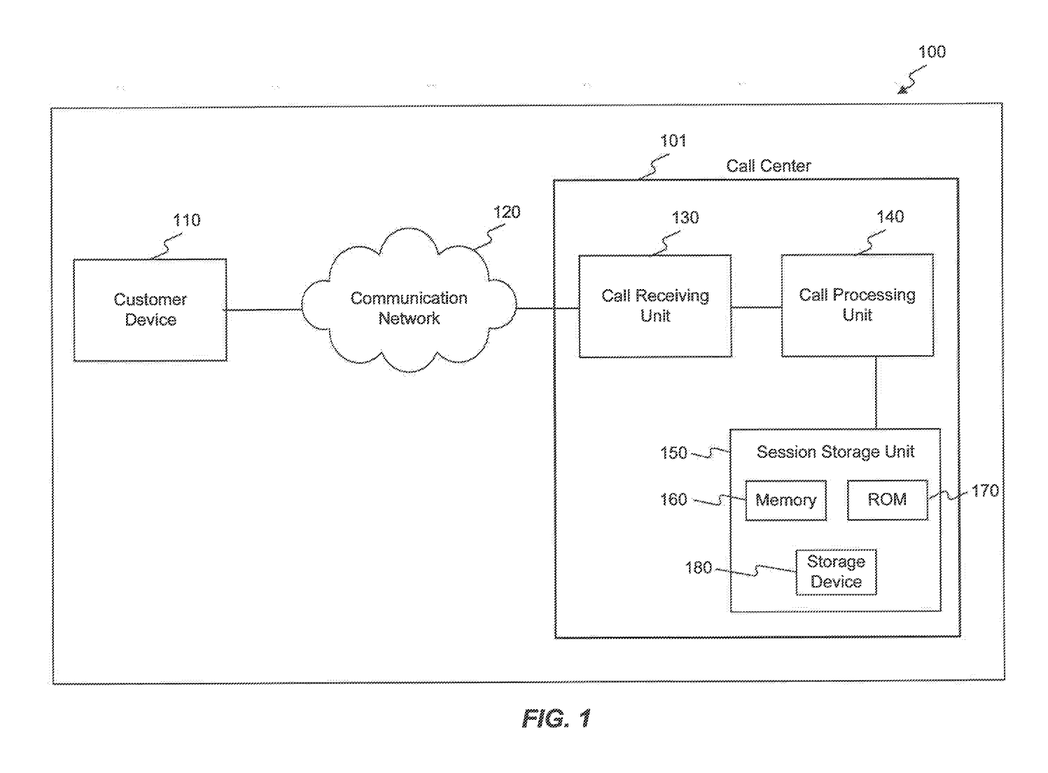

FIG. 1 is a functional block diagram of an exemplary system for managing calls received by a call center, consistent with an embodiment of the present invention. System 100 may include a Customer Device 110, a Communication Network 120, and a Call Center 101. Call Center 101 may comprise a Call Receiving Unit 130, a Call Processing Unit 140, and a Session Storage Unit 150.

Customer Device 110 may comprise any device capable of sending information to another device. For instance, Customer Device 110 may include devices such as a plain old telephone system (POTS) handset, an Integrated Services Digital Network (ISDN) device, a cellular telephone device, a voice over Internet Protocol (VoIP) device, or different types of telephone devices such as a web-enabled cellular device or an Internet Protocol (IP) telephone. Customer Device 110 may also include various types of computing devices such as a desktop computer, a laptop computer, a client, a server, a pager, a personal digital assistant (PDA), or another computation or communication device.

In one aspect, Customer Device 110 may be implemented using any device capable of accessing the Internet, such as a general-purpose computer or personal computer equipped with a modem. In one embodiment, Customer Device 110 may use instant messaging (“IM”) to communicate with Call Receiving Unit 130. In addition, Customer Device 110 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Customer Device 110 may establish a call connection with Call Receiving Unit 130 directly or indirectly, for instance, by transmitting call data to an intermediate device that may subsequently forward the call data to Call Receiving Unit 130 on behalf of Customer Device 110. During the call connection, Customer Device 110 may exchange, with Call Receiving Unit 130, a variety of media information as part of the call data, such speech, video, text, images or numerical data. Customer Device 110 may exchange such media directly or indirectly with Call Receiving Unit 130. Further, Customer Device 110 may transmit the call data over the same or over different communication channels. In other aspects, Customer Device 110 may send analog and/or digital call data and/or media, including non-packet-based and/or packet based information.

Communication Network 120 may comprise any data network capable of transmitting or transferring information such as local area networks (LANs), public telephone switching networks (PSTNs), wide area networks (WANs) such as the Internet, and/or metropolitan area networks (MANs). Communication Network 120 may operate using any appropriate network protocol, such as asynchronous transfer mode (ATM), Internet protocol (IP), Synchronous Digital Hierarchy (SDH), or synchronous optical network (SONET). Communication Network 120 may comprise network devices, such as gateways, servers, routers, switches, or firewalls. Communication Network 120 may be a wireless network using free-space optical and/or radio frequency transmission paths; or may be a hardwired network using wired conductors and/or optical fibers. Implementations of networks and/or devices operating on networks described herein are not limited to any particular data type, and/or protocol.

LAN or WAN networking environments are commonplace in offices, enterprise-wide computer networks, intranets, and the Internet, and are known by those skilled in the art. When a LAN is used as Communication Network 120, a network interface may be used for interconnection with either Customer Device 110 or Call Receiving Unit 130. When Communication Network 120 is implemented in a WAN networking environment, such as the Internet, an internal or external modem or other means for establishing communications over the WAN may be used. Further, in utilizing Communication Network 120, data sent over Communication Network 120 may be encrypted to ensure data security by using known encryption/decryption techniques.

In addition to utilizing a wireline communications system as Communication Network 120, a wireless communications system or a combination of wireline and wireless may be utilized as Communication Network 120. “Wireless” generally refers to radio transmission via the airwaves, such as cellular, microwave, satellite, packet radio and spread spectrum radio. However, it may be appreciated that various other communication techniques can be used to provide wireless transmission, including infrared line-of-sight. Wireless data may include, but is not limited to, voice data, paging, text messaging, e-mail, Internet access, and other specialized data.

In other aspects, Communication Network 120 may provide telephony services to allow a Customer Device 110 to place a telephone call. Communication Network 120 may be implemented using a network, such as the Public Switched Telephone Network. Alternatively, Communication Network 120 may be implemented on a voice-over-broadband network, such as a network using VoIP technology. Additionally, in other embodiments, Communication Network 120 may be a video-over-broadband network, such as, for example, a network for providing two-way video communications. In another example, Communication Network 120 may be a wireless broadband network, such as, for example, a network using WiFi (for instance, IEEE 802.11(b) and/or (g)). In yet another example, Communication Network 120 may be a wireless voice network(s), such as, for example, a cellular or third-generation cellular network. In addition, Communication Network 120 may be implemented using any one or a combination of the above-described technologies, consistent with the principles of the present invention.

Call Receiving Unit 130 provides a platform for managing communications over received from Communication Network 120. Call Receiving Unit 130 may be implemented using a combination of hardware, software, and/or firmware. For example, Call Receiving Unit 130 may be implemented using a plurality of general-purpose computers or servers coupled by a network (not shown). Although Call Receiving Unit 130 is shown with direct connections to Communication Network 120, any number and type of network elements may be interposed between Call Receiving Unit 130 and Communication Network 120.

In other embodiments, Call Receiving Unit 130 may be implemented using a server, desktop computer, workstation, network computer, laptop computer, mainframe, Wi-Fi device, web-enabled cellular telephone, or other similar microcomputer-based workstation or network device. Call Receiving Unit 130 may comprise any of a variety of devices, including hand-held devices, multiprocessor systems, microprocessor-based or programmable sender electronic devices, minicomputers, mainframe computers, and the like. Call Receiving Unit 130 may also be implemented in distributed computing environments where tasks are performed by remote processing devices. Furthermore, Call Receiving Unit 130 may comprise a mobile terminal, such as a smart phone, a cellular telephone, a cellular telephone utilizing wireless application protocol (WAP), FDA, intelligent pager, portable computer, a hand-held computer, a conventional telephone, or a facsimile machine.

In one embodiment, Call Receiving Unit 130 may include one or more devices that route traffic to and/or from Call Center 101, Call Receiving Unit 130 may be implemented inside Call Center 101 and/or on an edge of Communication Network 120. Call Receiving Unit 130 may include a device capable of receiving or transmitting information to another device or network. Further, Call Receiving Unit 130 may be connected to multiple Communication Networks 120, such as for example, Verizon's™ Voice Network, voice networks operated by other carriers, and wireless carrier networks.

Call Receiving Unit 130 may include an interactive voice response (IVR) application to route the incoming call according to inputs received from Customer Device 110. The IVR may comprise a computerized system that allows for automated handling of customer calls. The IVR may play pre-recorded digital audio prompts of multi-level menu options to which the customer responds, by either pressing numbers on a telephone keypad (for touch-tone telephones or where dual tone multi-frequency capabilities) or speaking to the system (for systems with automated speech recognition capabilities).

In another aspect, Call Receiving Unit 130 may be implemented as a session initiation protocol (SIP)-compliant device to enable Customer Device 110 and Call Processing Unit 140 to establish communication sessions using SIP-based messages. Call Receiving Unit 130 may perform call management functions, such as call setup, call monitoring, call teardown, or call reconnection, Call Receiving Unit 130 may include functionality of other types of devices, such as switches, routers, gateways, or firewalls, consistent with principles of the invention.

In other embodiments, Call Receiving Unit 130 may receive call data or media via a call connection from Customer Device 110. Call Receiving Unit 130 may further establish a link with the Call Processing Unit 140. Call Receiving Unit 130 may send the call information and/or media to Call Processing Unit 140 as part of a communication session.

Call Receiving Unit 130 may monitor call information and/or media during the communication session. Call Receiving Unit 130 may create a new link, such as a replacement link, and may send call information and/or media from Customer Device 110 to Call Processing Unit 140, or to another device.

Call Processing Unit 140 may be implemented using a server, desktop computer, workstation, network computer, laptop computer, mainframe, Wi-Fi device, web-enabled cellular telephone, or other similar microcomputer-based workstation or network device. Call Processing Unit 140 may comprise any appropriate type of computer operating devices, such as hand-held devices, multiprocessor systems, microprocessor-based or programmable sender electronic devices, minicomputers, mainframe computers, and the like. Call Processing Unit 140 may also be practiced in distributed computing environments where tasks are performed by remote processing devices. Furthermore, Call Processing Unit 140 may comprise a mobile terminal, such as a smart phone, a cellular telephone, a cellular telephone utilizing wireless application protocol (WAP), PDA, intelligent pager, portable computer, a hand held computer, a conventional telephone, or a facsimile machine.

In other aspects, Call Processing Unit 140 may comprise one or more automated call distribution (ACD) systems that automatically distribute customer calls to one or more telephone stations. Each ACD may route inbound telephone calls to telephone stations assigned to one or more agents. In other embodiments, the ACDs may initiate one or more outbound telephone calls using automated dialers and predictive dialing techniques, and then transfer the established calls to agents. ACDs may employ call queues and various distribution algorithms and methods, implemented in software as known to those skilled in the art, to enhance performance of the overall Call Processing Unit 140.

In one embodiment, Call Processing Unit 140 may comprise one or more devices configured to send and/or receive information related to a call or a Customer Device 110. Call Processing Unit 140 may include a device that displays or transmits out-of-band data (such as information from a service providers database), where the out-of-band data is related to in-band call data (such as voice data). The out-of-band data may include information about a calling party or a Customer Device 110, such as caller ID data, caller address data, and data about transactions recently requested and/or performed by the caller or via Customer Device 110.

Session Storage Unit 150 may comprise devices employing hardware- and/or software-based logic to store instructions, media, signaling data, measurement values, and/or other types of information related to call connections, such as call setup, call monitoring, call teardown, call reconnection, or call forking. For example, Session Storage Unit 150 may be implemented in a memory 160, a ROM 170, or a storage device 180.

Session Storage Unit 150 may include software capable of detecting a call interruption between a Customer Device 110 and an agent. The software may keep track of the session information of Call Receiving Unit 130 and Call Processing Unit 140 during the interaction between the customer and an agent, such as one or more steps in a troubleshooting process initiated by the agent. The software may store and may retrieve the stored session information when Customer Device 110 re-establishes connection with either Call Receiving Unit 130 or Call Processing Unit 140.

Session Storage Unit 150 may contain databases including specialized databases as would be recognized by one skilled in the art. Alternatively, the information stored in Session Storage Unit 150 could be maintained in structured or unstructured form using a standard file, spreadsheet, or other data assemblage for information storage and retrieval, as is known in the art.

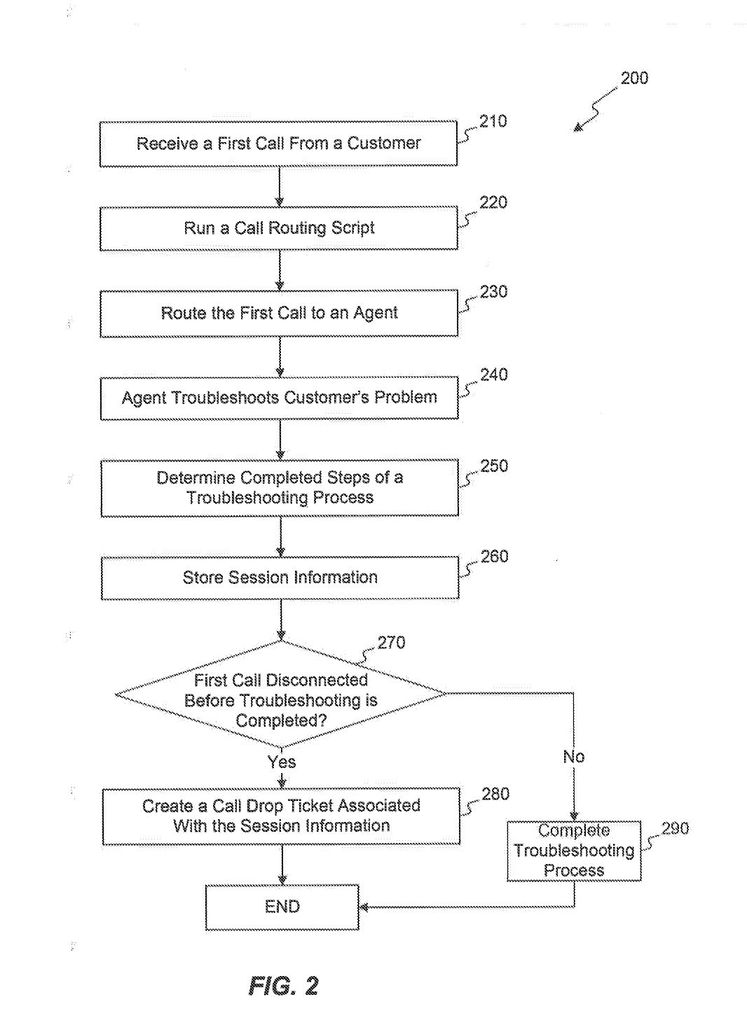

FIG. 2 is a flow chart of an exemplary method for managing calls, such as calls received by Call Center 101, consistent with an embodiment of the present invention.

In Step 210, Call Receiving Unit 130 receives a first call from a customer. The customer may dial Call Center 101 using Customer Device 110 to obtain help with a problem. The call, which may be made through Communication Network 120, may include a request for a communication session between Customer Device 110 and a destination device, such as Call Receiving Unit 130. The request may include information that identifies Customer Device 110 and Call Receiving Unit 130, such as a telephone number, IP address, or SIP address.

In step 220, Call Receiving Unit 130 runs a call routing script that may categorize the customers call. The call routing script may be part of the IVR that may be included in Call Receiving Unit 130 to route incoming calls according to inputs received from Customer Device 110. The IVR may authenticate the customer by asking for personal data such as the customers personal identification number (PIN), social security number, date of birth, or mothers maiden name. The IVR may alternatively identify the customer using the number associated with Customer Device 110, or via an alternative number entered by the customer.

The IVR may include one or more decision trees specifying a plurality of choices that can be taken when communicating with the IVR system. As the customer navigates the menu options and makes menu selections, the IVR may collect and interpret information entered by the customer. The IVR may also include pre-recorded audible responses triggered for playback in response to a user input process or scripts such as Voice Extensible Markup Language (VXML) compliant scripts, or dynamically generate audible responses, such as through a text-to-speech (TTS) system.

For instance, a call routing script may automatically guide the customer through a variety of steps to categorize the customer's call prior to routing the customer to an agent. The customer may be required to interactively make selections during the call routing process. For example, the customer may need to “Press 1 for Repair” or “Press 2 for Ordering.” In another example, after the customer makes the first selection, the call routing script may ask the customer to make an additional selection based on the first selection. For instance, if the customer presses 1 for Repair, the call routing script may automatically initiate a second voice prompt requesting the user to make additional selections, for example, “Press 1 for Voice Problems,” “Press 2 for Video Problems,” or “Press 3 for Internet Problems.”

In step 230, Call Receiving Unit 130 may route the first call to an agent. Call Receiving Unit 130 may process the customer's call according to inputs received via Customer Device 110, and forward the call to Call Processing Unit 140. Call Processing Unit 140 may forward the call to an agent.

If Call Processing Unit 140 determines that no agent is available to provide service to the customer, Call Processing Unit 140 may place the customer in a service queue, which may be a general queue into which all customers awaiting connection to an agent are placed, or may be associated with a specific agent appropriate for the customer's issue or category, for instance, as determined by Call Receiving Unit 130. Once the customer is placed in a service queue, the customer may remain in the queue until Call Processing Unit 140 determines that an agent is available.

In step 240, the agent and the customer interact, and the agent initiates a troubleshooting process to address the customer's problem. The interaction between the agent and the customer may include a discussion of problems or issues which the caller is seeking to resolve, and may involve the agent logging information associated with the issues. While substantially any type of connection may be made between the caller and the agent, Call Processing Unit 140 may facilitate a point-to-point connection between the customer and the agent.

The troubleshooting process may include the agent accessing troubleshooting software or hardware, which may be part of, or separate from, the Call Processing Unit 140. To carry out the troubleshooting process, the agent may log information pertaining to the customer's issue or request. The agent may need to initiate a series of steps or click through a series of screens or interfaces of software associated with Call Processing Unit 140. The agent may provide the customer with instructions for resolving the problem. In one embodiment, as part of the troubleshooting process, the user may initiate a series of steps in Customer Device 110.

In step 250, Call Processing Unit 140 may determine the completed steps of the troubleshooting process. Call Processing Unit 140 may monitor the steps performed as part of the troubleshooting process, including steps initiated by the agent in Call Processing Unit 140 and any steps initiated by the customer in Customer Device 110.

In step 260, Session Storage Unit 150 may store the session information related to the interaction between the agent and the customer. Once the customer is connected to the agent, Session Storage Unit 150 may obtain and store run-time state information or session information associated with interaction. It should be appreciated that instead of storing the session information when it is obtained, the run-time state information may instead be obtained without being stored at substantially the same time. In one aspect, Session Storage Unit 150 may save the last step of the troubleshooting process. In other aspects, Session Storage Unit 150 may save all session information, including a screen of the troubleshooting process at which the agent left off. The session information may also include additional information such as a phone number or other Customer Device 110 identifier, agent identifying information, a serial number of a product for which service is desired, or the type of service. In other embodiments, the session information may also be stored in cache memory on Call Processing Unit 140 or Call Receiving Unit 130.

In step 270, Call Processing Unit 140 determines whether the first call has been disconnected before the troubleshooting process is completed. For example, the first call may be interrupted prematurely due to a customer-side fault, a call center-side fault, or a fault of an intermediate third party. In one embodiment, Call Processing Unit 140 may monitor and log incoming and/or outgoing signaling messages and/or media throughout the duration of a call in order to determine the status of the call. Call Processing Unit 140 may monitor and log portions of the call using a variety of techniques. For example, Call Processing Unit 140 may monitor and log portions of the call and May make decisions based on the monitoring according to one or more configurable algorithms. The algorithms may reside locally on Call Processing Unit 140, and/or may be retrieved from a remote device. The algorithms may configure Call Processing Unit 140 to act automatically based on the monitoring and logging, or may configure Call Processing Unit 140 to act based on instructions received from either the Customer Device 110 or the agent. For example, Call Processing Unit 140 may listen for an in-band signal, such as a dual tone multi-frequency (DTMF) signal, and/or an out-of-band signal, such as a signal received from a button on a touch-sensitive display device.

In step 280, if Call Processing Unit determines that the first call has been disconnected before the troubleshooting process is complete, Call Processing Unit 140 may automatically create a call drop ticket associated with the session information stored in Session Storage Unit 150. In another embodiment, the agent may create the call drop ticket, including the details of the session information logged during the call. The session information stored in Session Storage Unit 150 may be used to reconnect Customer Device 110 to an agent in a case in which the agent and the customer are disconnected before the customers issues are resolved during the first call. The agent may also log, in the call drop ticket or the session information, additional information pertaining to the issues discussed in the first call.

In step 290, if the customer has not been disconnected, the agent completes the troubleshooting process. The agent may complete the steps, screens, or interfaces of the troubleshooting software in Call Processing Unit 140. The agent may provide the customer with instructions for resolving the problem and request the customer to complete the steps in Customer Device 110, Call Processing Unit 140 may allow the agent to flag the issue as “resolved.”

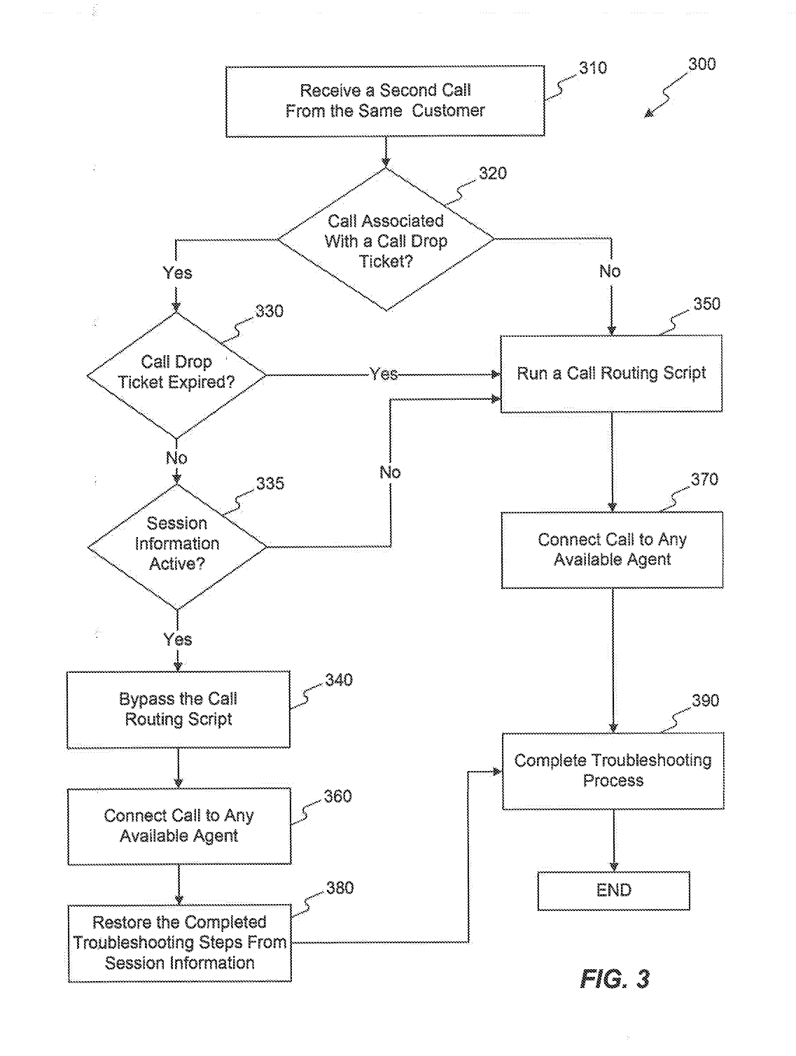

FIG. 3 is a flow chart of an exemplary method for managing call setup, call routing/re-routing, and call reconnections in Call Center 101, consistent with an embodiment of the present invention.

In step 310, Call Receiving Unit 130 receives a second call from the same customer. The customer may dial Call Center 101 using Customer Device 110 or through a registered alternate number associated with the customer's account. The call, which may be made through Communication Network 120, may include a request for a communication session between Customer Device 110 and a destination device, such as Call Receiving Unit 130. The request may include information that identifies Customer Device 110 and Call Receiving Unit 130, such as a telephone number, IP address, or SIP address.

In step 320, Call Receiving Unit 130 determines whether the second call is associated with an existing call drop ticket. Call Receiving Unit 130 may review the customer identifier, such as Customer Device 110 number, and perform a comparison or lookup against existing call drop tickets, and associated session information, stored in Session Storage Unit 150. Call Receiving Unit 130 may perform the lookup against substantially all the stored information in Session Storage Unit 150. Call Receiving Unit 130 may also perform a lookup against any runtime or session information stored in cache memory of Call Processing Unit 140 or Call Receiving Unit 130.

In step 330, if Call Receiving Unit 130 determines that there is an existing call drop ticket associated with the customer, Call Receiving Unit 130 determines whether the call drop ticket has expired. The call drop ticket may be configured to expire after a predetermined period of time. This period of time may be set arbitrarily, such as a preset maximum or minimum time period, or may be configured, for instance, based on the average customer callback timeframe, such as 24 hours. Session Storage Unit 150 may delete the stored call drop ticket or may flag the call drop ticket as expired.

In step 335, if Call Receiving Unit 130 determines that the call drop ticket has not expired, Call Receiving Unit 130 determines whether the session information related to the call drop ticket is still active. The session information may be configured to become inactive or expire coincident with expiration of the call drop ticket, or after some other period of time. This period of time may be set arbitrarily, such as a preset maximum or minimum time period, or may be configured, for instance, based on the average customer callback timeframe, such as 24 hours. Session Storage Unit 150 may delete the stored session information or may flag the session information as inactive or expired.

In step 340, if Call Receiving Unit 130 determines that the session information related to the call drop ticket is still active, Call Receiving Unit 130 may bypass the call routing script and automatically route the customer to the next available agent. In one embodiment, Call Receiving Unit 130 may use the information from the call drop ticket or the session information to automatically categorize the customer's call and to route the customer to an available agent.

In another embodiment, Call Receiving Unit 130 may assign the user to the beginning of a service queue if an agent is not available. In other embodiments, Call Receiving Unit 130 may create a special queue for calls that bypass the call routing script thereby allowing these calls to receive priority service.

Step 350 is initiated if Call Receiving Unit 130 determines that the second call has no associated call drop ticket, if Call Receiving Unit 130 determines that the call drop ticket associated with the second call has expired, or if Call Receiving Unit 130 determines that the session information associated with the call is inactive. In step 350, Call Receiving Unit 130 runs a call routing script that may categorize the customer's call. The call routing script may be part of the IVR that may be included in Call Receiving Unit 130 to route incoming calls according to inputs received from Customer Device 110. The IVR may authenticate the customer by asking for personal data such as the customer's the personal identification number (PIN), social security number, date of birth, or mother's maiden name. The IVR may alternatively identify the customer using the number associated with Customer Device 110, or via an alternative number entered by the customer.

In step 360, Call Receiving Unit 130 may route the second call to a second agent, the next available agent, which may or may not be the same agent that received the first call. Call Processing Unit 140 may display to the second agent the call drop ticket associated with the second call and the related session information, including the completed steps of the troubleshooting process.

In step 370, Call Receiving Unit 130 may route the call to an agent. Call Receiving Unit 130 may process the customer's call in the same manner as the first call. Call Processing Unit 140 may monitor the any steps initiated as part of the troubleshooting process, including steps initiated by the second agent in Call Processing Unit 140 and any steps initiated by the customer in Customer Device 110. In addition, Session Storage Unit 150 may store the session information related to the interaction between the agent and the customer. Once the customer is connected to the agent, Session Storage Unit 150 may obtain and stores run-time state information or session information associated with interaction. In other aspects, Session Storage Unit 150 may save the all session information. In other embodiments, the session information may also be stored in cache memory on Call Processing Unit 140 or Call Receiving Unit 130.

In step 380, Call Processing Unit 140 may restore the session information from the first call, including the completed troubleshooting steps. The agent and the customer may then interact and the agent may continue the troubleshooting process from the last step completed before the first call was terminated. The interaction between the agent and the customer may include an additional discussion of problems or issues with which the caller is seeking to resolve, and may involve the agent logging information associated with the issues.

In step 390, if the customer is not disconnected, the agent completes the troubleshooting process. The agent may complete the series of steps or complete the series of screens or interfaces of the troubleshooting software in Call Processing Unit 140. The agent may provide the customer with instructions for resolving the problem and allow the customer to complete the steps in Customer Device 110. Call Processing Unit 140 may allow the agent to flag the issue as resolved.

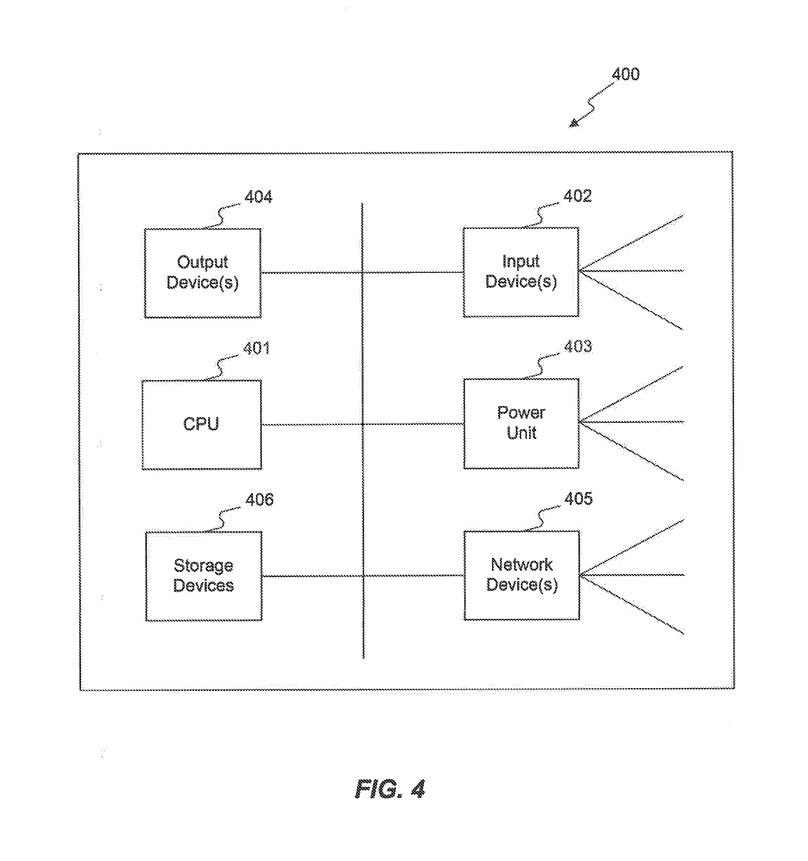

FIG. 4 is an exemplary computing device 400, consistent with disclosed embodiments. Although the description may refer to terms commonly used in describing particular computer systems, such as a personal computer, the description and concepts equally apply to other computer systems, such as network computers, workstations, and even mainframe computers having architectures dissimilar to FIG. 4.

As shown in FIG. 4, exemplary computer device 400 may include one or more central processing units 401 for managing and processing data and operations consistent with the disclosed embodiments. CPU 401 may be configured to process data, execute software instructions stored in memory, and transmit data between the other components of device 400. For example, CPU 401 may be implemented as a conventional microprocessor, a mobile microprocessor, a desktop microprocessor, a server microprocessor, or any other type of processor.

In some embodiments, computer device 400 may also include one or more input devices 402, which are configured to receive input from a user, other computers, other devices, or other modules. Input devices 402 may include, but are not limited to, keyboards, mice, trackballs, trackpads, scanners, cameras, external storage or information devices, and other devices, which connect via Universal Serial Bus (USB), serial, parallel, infrared, wireless, wired, or other connections.

Computer device 400 may also include one or more power units 403, which may supply operating power to computer device 400 and its components from one or more sources.

Computer device 400 also includes one or more output devices 404 that may be configured to transmit data to users and/or modules or devices. Such modules or devices may include, but are not limited to, computer monitors, televisions, screens, interface ports, projectors, printers, plotters, and other recording/displaying devices which connect via wired or wireless connections.

Computer device 400 may also include one or more network devices 405. Network device 405 may be configured to allow computer device 400 to connect to and exchange information with one or more networks, such as the Internet, a local area network, a wide area network, a cellular network, a wireless network, or any other type of network. Network device 405 may be implemented as a wired network adapter, a wireless network adapter, an infrared network adapter, a cellular or satellite network adapter, or any other type of network adapter.

Computer device 400 may also include one or more storage devices 406. Storage devices 406 may be comprise optical, magnetic, electronic, or any other type of memory configured to store information. Storage devices 406 may store, for example, data, instructions, programs/applications, operating systems, or a combination of these.

While FIG. 4 illustrates the components of device 400 as connected in a “bus” configuration, other connections and configurations are possible. Additionally, while the devices in FIG. 4 are represented in a singular form, in some embodiments, each of the devices in FIG. 4 may be omitted, duplicated, substituted, or more than one of each of the devices in FIG. 4 may be implemented.

Operation of computer system 400 is generally controlled and coordinated by operating system software. The operating system controls allocation of system resources and performs tasks, such as memory management, process scheduling, networking, and services, among other things.

Various embodiments have been described with reference to the accompanying drawings and embodiments. It will, however, be evident that various modifications and changes may be made thereto, and additional embodiments may be implemented, without departing from the present disclosure. The specification and drawings are accordingly to be regarded in an illustrative rather than restrictive sense.

For example, advantageous results may still be achieved if steps of the disclosed methods were performed in a different order and/or if components in the disclosed systems were combined in a different manner and/or replaced or supplemented by other components. Advantageous results may still be achieved if values or data were different than explicitly disclosed. Other implementations are also within the scope of the present disclosure.

Furthermore, although embodiments of the present invention have been described as being associated with data stored in memory and other storage mediums, one skilled in the art will appreciate that these aspects can also be stored on or read from other types of computer-readable media, such as secondary storage devices, hard disks, floppy disks, a CD-ROM, or other forms of RAM or ROM. Further, the steps of the disclosed methods may be modified in any manner, including by reordering steps and/or inserting or deleting steps, without departing from the principles of the invention.

It is intended, therefore, that the specification be considered as exemplary only, with a true scope and spirit of the invention being indicated by the following claims and their full scope of equivalents.

1. A system for managing calls received by a call center, comprising:
a call receiving unit configured to receive a first call from a customer device via a communication network and route the first call to a first agent;
a call processing unit configured to determine completed steps of a troubleshooting process; and
a session storage unit configured to store session information, the session information comprising a list of the completed steps of the troubleshooting process;
wherein:
the call processing unit is configured to create a call drop ticket associated with the session information if the first call is disconnected before all the steps of the troubleshooting process are completed;
the call receiving unit is configured to:
receive a second call from the customer device via the communication network;
determine whether the second call is associated with the call drop ticket; and
route the second call to a second agent if the second call is associated with the call drop ticket; and
the call processing unit is configured to display to the second agent the completed steps stored in the session information if the second call is associated with the call drop ticket.

2. The system as recited in claim 1, wherein the call processing unit is configured to:
selectively run a script soliciting and receiving from the customer a plurality of information items related to the first call; and
bypass running of the script if the second call is associated with the call drop ticket.

3. The system as recited in claim 1, wherein the call drop ticket is configured to expire after a predetermined period of time.

4. The system as recited in claim 1, wherein the session storage unit is configured to store the session information for a predetermined period of time.

5. The system as recited in claim 1, wherein the session information comprises at least one of a last step of the troubleshooting process or a last screen of the troubleshooting process.

6. The system as recited in claim 1, wherein the call processing unit is further configured to restore, from the session information, the completed steps of the troubleshooting process.

7. The system as recited in claim 1, wherein the second agent is the same as the first agent.

8. A computer-implemented method for managing calls received by a call center, comprising:
receiving, by a processor connected to at least one network database, a first call from a customer device via a communication network and routing, by the processor, the first call to a first agent;
determining, by the processor, completed steps of a troubleshooting process;
storing, by the processor, in the at least one network database, session information, the session information comprising a list of the completed steps of the troubleshooting process;
creating, by the processor, a call drop ticket associated with the session information if the first call is disconnected before all the steps of the troubleshooting process are completed;
receiving, by the processor, a second call from the customer device via the communication network;
determining, by the processor, whether the second call is associated with the call drop ticket;
routing, by the processor, the second call to a second agent if the second call is associated with the call drop ticket; and
displaying, by the processor to the second agent, the completed steps stored in the session information if the second call is associated with the call drop ticket.

9. The method as recited in claim 8, further comprising:
selectively running, by the processor, a script soliciting and receiving from the customer a plurality of information items related to the first call; and
bypass running of the script, by the processor, if the second call is associated with the call drop ticket.

10. The method as recited in claim 8, wherein the call drop ticket is configured to expire after a predetermined period of time.

11. The method as recited in claim 8, wherein the session information is stored for a predetermined period of time.

12. The method as recited in claim 8, wherein the session information comprises at least one of a last step of the troubleshooting process or a last screen of the troubleshooting process.

13. The method as recited in claim 8, further comprising:
restoring from the session information, by the processor, the completed steps of the troubleshooting process.

14. The system as recited in claim 8, wherein the second agent is the same as the first agent.

15. A non-transitory computer-readable medium storing instructions that, when executed by a processor, cause the processor to perform operations comprising:
receiving a first call from a customer device via a communication network and routing the first call to a first agent;
determining completed steps of a troubleshooting process;
storing session information, the session information comprising a list of the completed steps of the troubleshooting process;
creating a call drop ticket associated with the session information if the first call is disconnected before all the steps of the troubleshooting process are completed;
receiving a second call from the customer device via the communication network;
determining whether the second call is associated with the call drop ticket;
routing the second call to a second agent if the second call is associated with the call drop ticket; and
displaying to the second agent the completed steps stored in the session information if the second call is associated with the call drop ticket.

16. The medium as recited in claim 15, wherein the instructions cause the processor to perform operations further comprising:
selectively running a script soliciting and receiving from the customer a plurality of information items categorizing the first call; and
bypass running of the script if the second call is associated with the call drop ticket.

17. The medium as recited in claim 15, wherein the call drop ticket is configured to expire after a predetermined period of time.

18. The medium as recited in claim 15, wherein the session information is stored for a predetermined period of time.

19. The medium as recited in claim 15, wherein the session information comprises at least one of a last step of the troubleshooting process or a last screen of the troubleshooting process.

20. The medium as recited in claim 15, wherein the instructions cause the processor to perform operations further comprising:
restoring, from the session information, the completed steps of the troubleshooting process.

21. The system as recited in claim 15, wherein the second agent is the same as the first agent.
